(19) United States
(12) Patent Application Publication
(10) Pub. No.: US 2020/0109029 A1
(43) Pub. Date: Apr. 9, 2020

(54) COMMISSIONING TOOL FOR ASSOCIATION OF CONNECTED DEVICES

(71) Applicant: Otis Elevator Company, Farmington, CT (US)

(72) Inventors: Derk Oscar Pahlke, Berlin (DE); Tadeusz Pawel Witczak, Farmington, CT (US); Craig Drew Bogli, Avon, CT (US)

(21) Appl. No.: 16/154,222

(22) Filed: Oct. 8, 2018

(51) Int. Cl. B66B 5/00; H04L 29/08; H04W 4/029; H04W 4/02; G06F 17/30; H04W 4/80

(52) U.S. Cl. CPC B66B 5/0018; H04L 67/12; H04W 4/80; H04W 4/025; G06F 17/30595; H04W 4/029

(57) ABSTRACT

Provided are embodiments for operating a commissioning tool for associating connected devices. The embodiments include receiving commissioning data for one or more devices corresponding to equipment, and associating location information of the user device with the commissioning data for the one or more devices, wherein the user device is operably coupled to the one or more devices. The embodiments also include transmitting the location information and the commissioning data to a server, and storing the association of the location information with the commissioning data in the server.

### BACKGROUND

The embodiments herein relate to installation tools and more particularly to a commissioning tool for associating connected devices.

Many systems require routine maintenance where one or more components are repaired and/or replaced. After a new component is installed the newly installed devices must undergo a commissioning phase to initialize the new components with the system. The commissioning phase typically includes testing, operating and maintaining the operation of the equipment. The data that is related to each component can be obtained by an operator or technician and made available for further service.

### SUMMARY

According to an embodiment, a system for operating a commissioning tool for associating connected devices is provided. The system includes a controller operably coupled to one or more sensing devices, wherein the one or more sensing devices are configured to detect sensing data from a system; a user device operably coupled to the one or more sensing devices and the controller, wherein the user device is configured to receive commissioning data from the one or more sensing devices and the controller, and the user device is configured to determine location information; and a server configured to store the commissioning data with the determined location information, wherein the server is configured to receive the commissioning data from the user device.

In addition to one or more of the features described herein, or as an alternative, further embodiments include a controller that is associated with at least one of an elevator system, escalator system, or remote sensing system.

In addition to one or more of the features described herein, or as an alternative, further embodiments include a gateway that is configured to relay data between the server and the one or more sensing devices.

In addition to one or more of the features described herein, or as an alternative, further embodiments include commissioning data having one or more of a unique universal identifier (UUID), manufacturer information, model number, serial number, or unit number for the controller and the one or more sensing devices.

In addition to one or more of the features described herein, or as an alternative, further embodiments include a user device having an input device that is at least one of an image capture device, a bar code scanner, or a beacon detector.

In addition to one or more of the features described herein, or as an alternative, further embodiments include location information that is based on at least one of GPS coordinates of the user device or a tower-based location data of the user device.

In addition to one or more of the features described herein, or as an alternative, further embodiments include a user device that is configured to identify one or more additional devices that are within proximity of the user device based the commissioning data and the location information, and the user device is configured to monitor the one or more additional devices.

In addition to one or more of the features described herein, or as an alternative, further embodiments include a user device having a communication interface that is configured to communicate using at least one of RFID technology, NFC technology, ZigBee, Z-wave, short-range technology, or Bluetooth technology.

In addition to one or more of the features described herein, or as an alternative, further embodiments include a user device that is at least one of a smart phone, tablet, or mobile device.

In addition to one or more of the features described herein, or as an alternative, further embodiments include an image processor to determine the commissioning data from the received input.

According to another embodiment, a method for operating a commissioning tool for associating connected devices is provided. The method includes receiving, by a processor of a user device, commissioning data for one or more devices corresponding to equipment; associating location information of the user device with the commissioning data for the one or more devices, wherein the user device is operably coupled to the one or more devices; transmitting the location information and the commissioning data to a server; and storing the association of the location information with the commissioning data in the server.

In addition to one or more of the features described herein, or as an alternative, further embodiments include a gateway that is configured to relay data between the server and the one or more devices.

In addition to one or more of the features described herein, or as an alternative, further embodiments include commissioning data having one or more of a unique universal identifier (UUID), manufacturer information, model number, serial number, or unit number for a controller and the one or more devices.

In addition to one or more of the features described herein, or as an alternative, further embodiments include at least one of a gateway, a controller, or sensing devices configured to obtain sensor data from the equipment.

In addition to one or more of the features described herein, or as an alternative, further embodiments include collecting the sensor data; and associating the sensor data with the commissioning data.

In addition to one or more of the features described herein, or as an alternative, further embodiments include commissioning data that is received by performing image processing of at least one of a tag of the equipment or the one or more devices.

In addition to one or more of the features described herein, or as an alternative, further embodiments include commissioning data that is received by performing a bar code scan of the one or more devices.

In addition to one or more of the features described herein, or as an alternative, further embodiments include commissioning data that is received using at least one of beacon technology, RFID technology, NFC technology, ZigBee, Z-wave, short-range technology, or Bluetooth low energy technology.

In addition to one or more of the features described herein, or as an alternative, further embodiments include location information that is based on at least one of GPS coordinates of the user device or a tower based location of the user device.

In addition to one or more of the features described herein, or as an alternative, further embodiments include identifying one or more additional devices that are within proximity of the user device based the commissioning data and the location information; and monitoring the one or more additional devices.

Technical effects of embodiments of the present disclosure include automatically performing the commissioning of one or more connected devices of the system.

The foregoing features and elements may be combined in various combinations without exclusivity unless expressly indicated otherwise. These features and elements, as well as the operation thereof, will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 depicts a system for operating a commissioning tool for associating connected devices in accordance with one or more embodiments;

FIG. 3 depicts a user device for operating a commissioning tool for associating connected devices in accordance with one or more embodiments; and

FIG. 4 depicts a flowchart of a method for operating a commissioning tool for associated connected devices in accordance with one or more embodiments.

### DETAILED DESCRIPTION

During the installation of equipment and devices such as the Internet of Things (IoT) devices, a commissioning process is necessary to link and associate the data that is collected to a location of the installed equipment. The associations can be stored in a central database/server or stored in a distributed manner There are many types of data that can be collected and managed by the system including location information, unit serial numbers, customer information, etc. In one or more embodiments, the identifier can be a universal unique identifier (UUID) which can include but is not limited to a serial number, MAC address, factory number, and the like. The type of information that can be stored is not limited by the previous examples. However, given the different types of information, the manual entry of this information can be time consuming and any error in the data entry associating the equipment and devices can cause the collected data to be associated with the wrong devices potentially rendering the data unusable.

In addition, the database storing the information may be required to be manually updated by an operator or administrator. Any delay in updating the database can cause the latest data to be unavailable to the network. This can lead to one or more devices attempting to obtain data related to the device and equipment to be unsynchronized. The collected data may not be complete and up-to-date. The devices must be linked to a device in order to properly collect the data, such as sensor data, corresponding to the system.

The techniques described herein provide for using a commissioning tool for automatically inputting commissioning data into a system and updating the stored data associated with an installed device or equipment. The commissioning tool can be part of a user application that associates the commissioning data by scanning the commissioning, performing an image analysis, processing beacon signals, and/or other techniques.

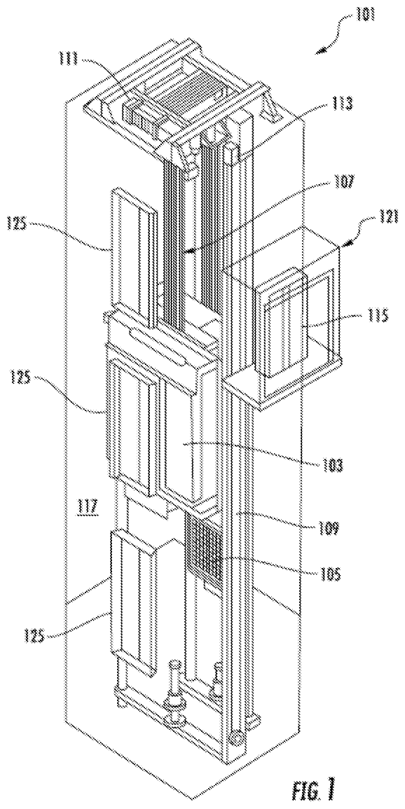

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1.

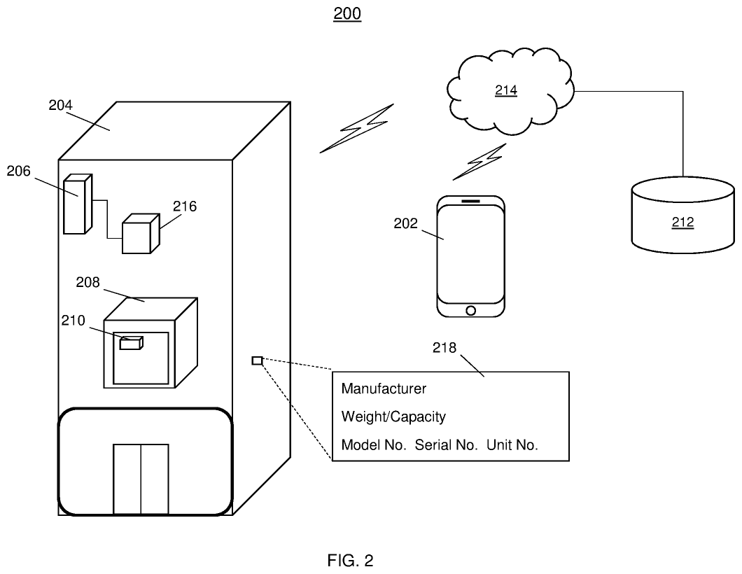

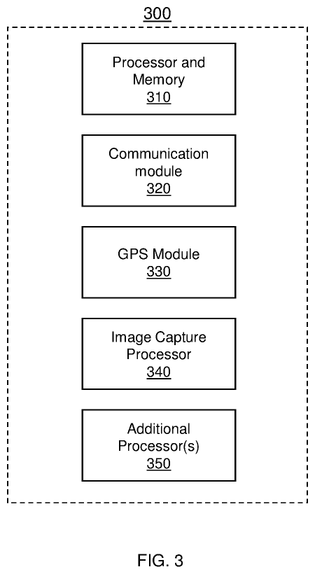

FIG. 2 depicts a system 200 for operating a commissioning tool for the association of connected devices in accordance with one or more embodiments of the invention. In one or more embodiments, the commissioning tool can include an application executed on a user device 202 that is configured to associate and link information of a newly installed device to a particular location. In a non-limiting example, the user device 202 is a mobile phone, tablet device, laptop, computing device, etc. that includes one or more processing components as shown in FIG. 3.

The system 200 includes an elevator system 204. The elevator system 204 can be a similar elevator system to that shown in FIG. 1. The elevator system 204 can include an elevator controller 206 which is configured to send commands and receive data to/from the elevator car 208 to control the operation of the elevator car 208. The controller 206 can be located in a known location such as its address and unit location which can be associated with other devices that are operably coupled to the controller 206. The elevator car 208 can be equipped with one or more sensor modules 210 to sense different states and conditions associated with the elevator car 208 such as the proper operation, elevator speed, elevator location, elevator door operation, etc. The sensor module 210 can be configured to detect sensor data from the elevator 208. In one or more embodiments, the sensor data obtained by the sensing module 210 can be stored in the server/database 212 over a network 214. In one or more embodiments, the sensor data from the sensing module 210 is relayed to the server 212 through the gateway 216.

The gateway 216 is configured to communicate with a network 214 to exchange data with a database 212, server, or user device 202. The gateway 216 can communicate over a wired and/or wireless connection and can relay the data between the sensors module 210 and the cloud. For example, the gateway 216 can push the sensor data from the sensing module 210 and communicate the sensor data using BLE or to a cloud using Global System for Mobile communication (GSM). In one or more embodiments, the gateway 216 can include a device ID of the installed device such as the gateway 216 or sensor module 210. The gateway 216 can be used when the gateway 216 is configured to collect data and associated with the collected ID.

The elevator system 204 can include a tag 218 which provides information related to the elevator system 204. The information can include a tag number, manufacturer information, model number, serial number, elevator location, year of installation, etc. In addition, the tag 218 can indicate the weight or capacity of the elevator car 208 or any other information related to the system 200. In a different embodiment, a label can be used instead of a tag 218 which can include the same or different information. It should be understood the commissioning of the equipment is not limited to elevators but can be applied to any type of device/equipment. Therefore, it should also be understood the commissioning data can include information beyond the location information, serial and model number of the device, a license number, etc.

The user device 202 can receive data from the sensing module 210 that indicates a unique identifier of the sensing module 210. In a non-limiting example, the sensing module 210 can be configured to transmit a Bluetooth beacon using Bluetooth Low Energy (BLE) technology to the user device 202 which indicates the unique identifier of the sensing module 210.

In one or more embodiments, the commissioning tool of the user device 202 can be configured to test the operability of the elevator 208 responsive to obtaining sensor data from the sensing module 210 and can be further configured to transmit the locally computed information indicating the operational status of the elevator 208 to a cloud network for global storage. The operational status can indicate a properly functioning state or an error state of the elevator car 208 or other associated devices. In one or more embodiments, the user device 202 can communicate with a controller such as elevator controller 206, or alternatively, the user device 202 can communicate directly with a remote database located in a cloud network.

In another non-limiting example, the user device 202 can include a scanner device that is configured to scan a QR code or other type of code such as a tag, bar code, or image that is associated with one or more components of the system such as the controller 206, the gateway 216, the sensing module 210 or the elevator car 208. The QR code can include all of the previously mentioned data including the unique identifier for the component, manufacturer information, model and serial numbers, etc.

In a different embodiment, the user device 202 can include an image capturing device to obtain an image of a tag 218, license plate and/or other label that provides information related to the elevator system 200. The image processing can be used to detect the characters, text, symbols, etc. on a license tag or the serial number of a device to input the data into the system 200. The image processing can be executed in the user device 202 or in one or more processors in the cloud network 214. After the image data is processed, the data can be transmitted to the database 212 and associated with the other connected devices.

In one or more embodiments, the commissioning data can be transmitted using different technologies including near-field communication (NFC), RFID, Bluetooth beacon technology, WiFi, short-range technology (e.g. Zwave, Zigbee), etc. The Bluetooth technology can include Bluetooth Low Energy (BLE). For example, when a user initiates the commissioning application on the user device 202, the user device 202 can obtain the unique identifier information for a series of one or more components/devices such as the sensing module, gateway, controller, etc. by tapping the user device 202 to the multiple sequences of devices to associate the plurality of devices during commissioning using the NFC technology. It should be understood the user device 202 is not limited to the technologies listed above but were provided as non-limiting examples.

In one or more embodiments, a hotel may have a plurality of elevators each having elevator controllers. There may be a need to identify a particular elevator (unit no) from the plurality of elevators. Each unique controller can include a unique serial number or identifier and its location can be associated with the connected devices.

The GPS module of a user device 202 may not be able to individually determine an elevator of a plurality of elevators at a particular location. In addition to obtaining the GPS coordinates of a location, the GPS module can be used to identify the building (street address), however, it may fail to identify the particular elevator in a system of elevators. The location of the installed device can be matched to the GPS data or as an alternative the geo location can be detected by a user device 202 during the commissioning phase. Alternatively, the location information can be generated by linking a location based cell tower association, detected by the user device 202, when scanning the QR of the installed device. Subsequently, the data associating the location and the installed device can be sent to the cloud for storage and/or further analysis. The system 200 can provide a prompt to a user to select and confirm the building/address proposed by the detected location.

In addition to image processing the license tag number, the image processing can be used to collect the serial number or other identifier from a label of the to-be-installed device. For example, the tag 218 includes the unit number from the tag and additional information including e.g., elevator type, max load information, manufacture, elevator door type (center opening, telescopic, 2-fold, etc.), controller/control board information, details of the control system, etc. The user device 202 can also store additional attribute information along with the commissioning data.

Responsive to commissioning the devices, the collected sensor data from the sensing module 210 can be linked to the particular equipment such as the elevator car 208 using the association information stored in the database 212. All of the commissioning data including the devices, equipment, location, customer contract data, etc. can be linked to the sensor data. This data can be made available to other user devices and systems for further analysis in a synchronized fashion. The data can be accessed by the user device 202 directly over the network 214 or using the remote satellite device/gateway 216 to access the database 212 over the network 214. The commissioning data can be presented on a display of the user device 202 along with a number of options for the user.

In a different embodiment, the commissioning data can be processed in the cloud to confirm the appropriate data has been entered and associated with one another and feedback from the cloud can be used to confirm the correct installation of the devices. The commissioning application is also operable to test the operability of the sensing module 210 by detecting a beacon of the sensing module 210.

In FIG. 3, a user device 300 used for operating the commissioning tool for associating connected devices in accordance with one or more embodiments is shown. In one or more embodiments, a user device 300 can be used to obtain the data during the commissioning phase of the equipment and/or one or more devices. The user device 300 can be configured with the appropriate interfaces such as a wireless communication interface to communicate with one or more components of the system 200. The user device 300 as shown include one or more modules and components that can be implemented in hardware and/or software or a combination thereof. The user device 300 includes a processor and memory 310 for operating the user device 300. The user device 300 includes a communication module 320 to communicate over a network such as a cellular network, Wi-Fi network, Bluetooth network, etc. The user device 300 can also be configured to communicate directly to the controller, gateway, sensing module, etc. In addition, the communication module 320 can include interfaces to communicate over various wired and/or wireless communication channels.

The user device 300 can include a GPS module 330 to obtain GPS data. The GPS data can include GPS coordinates and/or street address/building information. The user device 300 can also include input devices/modules including but not limited to a beacon detector, scanner, image capture device, etc. to receive the commissioning data. The user device 300 can include an image capture device and processor 340 to obtain an image such as an image of the license plate for a piece of equipment. Some equipment may include license plates that include information such as the manufacturer name, model number, serial number, manufacture date, etc. The user device 300 can include a display (not shown) configured to display the data. The data can be presented on the display graphically and textually. It should be understood that the user device 300 can also include a plurality of additional processor/modules 350.

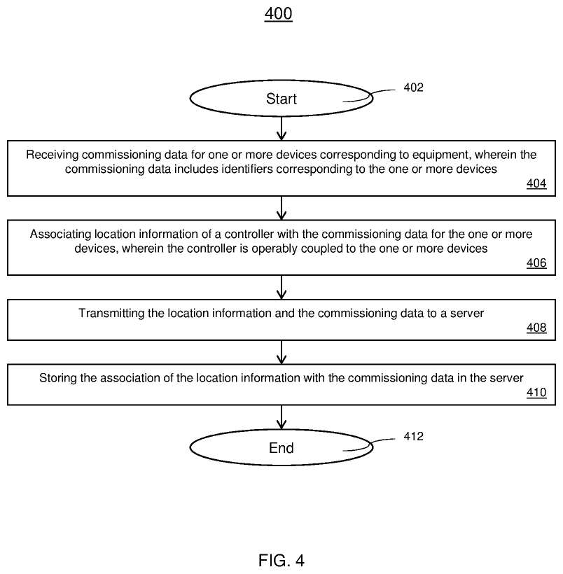

Now referring to FIG. 4, a flowchart of a method 400 for operating a commissioning tool for associating connected devices in accordance with one or more embodiments is shown. The method 400 begins at block 402 and proceeds to block 404 which provides for receiving commissioning data for one or more devices corresponding to equipment, wherein the data includes identifiers corresponding to the one or more devices. In one or more embodiments, the equipment can be an elevator or an escalator. The method 400, at block 406 provides for associating location information of a controller with the commissioning data for the one or more devices, wherein the controller is operably coupled to the one or more devices. Block 408 provides for transmitting the location information and the commissioning data to a server. In one or more embodiments, the server maintains stores the relationship between the devices, the equipment and the location of the equipment. Block 410 provides for storing the association of the location information with the commissioning data in the server. Supplemental information related to the devices can be stored with the commissioning data so that the most complete and up-to-date information is available. Responsive to associating the commission data, an operator or mechanic can monitor the devices based on the tag, code, image, elevator number, and associated sensors. In addition, the operator or mechanic can also locate the devices, sensors, controllers, etc. by a location on a map provided on the user interface of the user device or by a location of the devices that are in close proximity to user device. The method 400 ends at block 412.

The techniques described herein provide for efficient and accurate information entry into the system. Techniques include implementing Bluetooth beacon detection, RFID, NFC, image recognition, QR codes, and other techniques to obtain the commissioning data. The information obtained by the commissioning tool can be stored in a central location so other networked devices can access a synchronized view of the latest data. The commissioning tool also reduces the installation time for installing or replacing a new device or component. The commissioning process delay can be drastically decreased and the data from the devices can be consistently entered into the system.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system comprising:
a controller operably coupled to one or more sensing devices, wherein the one or more sensing devices are configured to detect sensing data from a system;
a user device operably coupled to the one or more sensing devices and the controller, wherein the user device is configured to receive commissioning data from the one or more sensing devices and the controller, and the user device is configured to determine location information; and
a server configured to store the commissioning data with the determined location information, wherein the server is configured to receive the commissioning data from the user device.

2. The system of claim 1, wherein the controller is associated with at least one of an elevator system, escalator system, or remote sensing system.

3. The system of claim 1, further comprising a gateway configured to relay data between the server and the one or more sensing devices.

4. The system of claim 3, wherein the commissioning data comprises one or more of a unique universal identifier (UUID), manufacturer information, model number, serial number, or unit number for the controller and the one or more sensing devices.

5. The system of claim 1, wherein the user device comprises an input device that is at least one of an image capture device, a bar code scanner, or a beacon detector.

6. The system of claim 1, wherein the location information is based on at least one of GPS coordinates of the user device or a tower-based location data of the user device.

7. The system of claim 1, wherein the user device is configured to identify one or more additional devices that are within proximity of the user device based the commissioning data and the location information, and the user device is configured to monitor the one or more additional devices.

8. The system of claim 1, wherein the user device comprises a communication interface that is configured to communicate using at least one of RFID technology, NFC technology, ZigBee, Z-wave, short-range technology, or Bluetooth technology.

9. The system of claim 1, wherein the user device is at least one of a smart phone, tablet, or mobile device.

10. The system of claim 1, further comprising an image processor to determine the commissioning data from the received input.

11. A method comprising:
receiving, by a processor of a user device, commissioning data for one or more devices corresponding to equipment;
associating location information of the user device with the commissioning data for the one or more devices, wherein the user device is operably coupled to the one or more devices;
transmitting the location information and the commissioning data to a server; and
storing the association of the location information with the commissioning data in the server.

12. The system of claim 11, further comprising a gateway configured to relay data between the server and the one or more devices.

13. The method of claim 11, wherein the commissioning data comprises one or more of a unique universal identifier (UUID), manufacturer information, model number, serial number, or unit number for a controller and the one or more devices.

14. The method of claim 10, wherein the one or more devices comprise at least one of a gateway, a controller, or sensing devices configured to obtain sensor data from the equipment.

15. The method of claim 11, further comprising collecting the sensor data; and
associating the sensor data with the commissioning data.

16. The method of claim 10, wherein the commissioning data is received by performing image processing of at least one of a tag of the equipment or the one or more devices.

17. The method of claim 10, wherein the commissioning data is received by performing a bar code scan of the one or more devices.

18. The method of claim 10, wherein the commissioning data is received using at least one of beacon technology, RFID technology, NFC technology, ZigBee, Z-wave, short-range technology, or Bluetooth low energy technology.

19. The method of claim 11, wherein the location information is based on at least one of GPS coordinates of the user device or a tower based location of the user device.

20. The method of claim 19, further comprising identifying one or more additional devices that are within proximity of the user device based the commissioning data and the location information; and
monitoring the one or more additional devices.
